(19) United States
(12) Patent Application Publication
(10) Pub. No.: US 2018/0352372 A1
(43) Pub. Date: Dec. 6, 2018

(54) SYSTEM, METHOD AND APPARATUS FOR GENERATING A ZONE RESTRICTING USE OF A MOBILE DEVICE

(71) Applicant: L'Ami Carl, LLC, Aliso Viejo, CA (US)

(72) Inventors: David Swartz, Newport Coast, CA (US); Andrew Simmons, Costa Mesa, CA (US); Jeffrey Lanzi, Irvine, CA (US); Michael Gilmore, Anaheim, CA (US); Frederick Thiel, Dana Point, CA (US)

(21) Appl. No.: 15/615,745

(22) Filed: Jun. 6, 2017

(51) Int. Cl. H04W 4/02; H04L 29/08; H04W 4/04; H04W 48/04; H04M 1/725; H04W 88/02

(52) U.S. Cl. CPC H04W 4/021; H04L 67/12; H04W 4/046; G06F 2221/2111; H04M 1/72577; H04W 4/04; H04W 88/022; H04W 48/04

(57) ABSTRACT

A method including steps of receiving, by a cloud server, a predefined list of one or more functionalities to restrict, the predefined list generated via user input and communicatively coupling, by a wireless transceiver, with a first network device is disclosed. Additional steps include transmitting, by the wireless transceiver, a first message to the first network device, the first message configured to prompt a software application installed on the first network device to obtain a value indicating a strength of a detected magnetic field, wherein the magnetic field is generated by one or more magnets, and responsive to the value indicating the strength of the detected magnetic field is greater than or equal to a first threshold, restricting, by the software application, the predefined list of one or more functionalities of the first network device.

### FIELD

Embodiments of the disclosure relate to the field of automobile safety. More specifically, one embodiment of the disclosure relates to a system that establishes a zone by emitting a magnetic field such that an application installed on a mobile device may disable predetermined functionalities of the mobile device dependent on the strength of the magnetic field, which is based on a distance from the mobile device to the device emitting the magnetic field.

### GENERAL BACKGROUND

Distractions while driving, especially those from electronic devices, are at an all-time high. As mobile devices, e.g., cell phones, have become ubiquitous, it is common place for a driver to get into an automobile, start driving and become distracted with his/her cell phone. For instance, drivers often receive and respond to text messages or emails, browse the internet, or browse social media platforms while driving.

Driving while distracted as a result of the presence of electronic devices within reach is a dangerous, and at times, deadly, situation. Although some states have outlawed the act of using a cell phone while driving, not all drivers regularly adhere to these laws. Additionally, drivers may be distracted merely by notification alerts received by a cell phone. For example, a cell phone placed in a cup holder of the center console may alert the driver to a new text message or email via an audible and/or visual notification. The notification may cause the driver to take his/her eyes off of the road momentarily, which has the potential to result in an accident.

Many parents or employers wish to prevent their children/employees from being distracted by the child's cell phone while driving but also want their children to have a cell phone in case of emergency. However, the use of some functionality of a cell phone may be warranted while driving. For example, a functionality of a cell phone that provides turn-by-turn directions may be used by some drivers and does not cause unnecessary distractions. Further, some drivers may be able to connect their cell phones to the automobile's audio system and play music while driving without causing unnecessary distractions. Additionally, once a child completes his/her drive, there is no need to prevent the child from using his/her cell phone.

Thus, a system, method and apparatus are needed to restrict the use of some or all functionality of certain network devices, such as mobile devices for example, within a predefined area of an interior cabin of an automobile when the automobile is in use.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1A is an exemplary illustration of Cell Free Zone (CFZ) system.

FIG. 1B is an exemplary illustration of an interior cabin of an automobile including the magnetic device and the wireless transceiver of FIG. 1A.

FIG. 1C is an exemplary block diagram of a magnetic device.

FIG. 2 is an exemplary illustration of an interior cabin of a second automobile including a magnetic device and a wireless transceiver installed therein.

FIG. 3 is an exemplary display screen illustrating an internet browser presenting an account owner registration webpage.

FIG. 4A is an exemplary illustration of a network device displaying a “Messages” screen presenting the user of the mobile device with a plurality of text message alerts.

FIG. 4B is an exemplary illustration of a network device displaying text messages from Cell Free Zone.

FIG. 4C is an exemplary illustration of a network device displaying a home screen including an icon corresponding to the software application.

FIG. 4D is an exemplary illustration of a network device displaying a first display screen of the software application.

FIG. 4E is an exemplary illustration of a network device displaying a second display screen of the software application.

FIG. 4F is an exemplary illustration of a network device displaying a third display screen of the software application.

FIG. 5A is an exemplary illustration of a network device displaying a “Messages” screen presenting the user of the mobile device with a plurality of text message alerts.

FIG. 5B is an exemplary illustration of a network device displaying text messages from Cell Free Zone.

FIG. 6A is a first exemplary illustration of an interior cabin of an automobile including a magnetic device installed therein.

FIG. 6B is a second exemplary illustration of the interior cabin of the automobile of FIG. 6A including the magnetic device installed therein

FIG. 6C a third exemplary illustration of the interior cabin of the automobile of FIG. 6A including the magnetic device installed therein.

FIG. 7A is an illustration of a wireless signal being transmitted to a network device.

FIG. 7B is an illustration of a magnetic field generated by a magnetic device and detected by the network device of FIG. 7A.

FIG. 8 is a flowchart illustrating an exemplary process for monitoring driving data and providing notifications corresponding thereto.

FIG. 9 is a flowchart illustrating an exemplary process for providing notifications corresponding to a child's driving.

### DETAILED DESCRIPTION

Embodiments of a system, apparatus and method for disabling predefined functionalities of a network device within a predefined range of a magnetic device are described. A Cell Free Zone (CFZ) system is capable of configuring, with a software application of a network device, a restricted area having a magnetic device as a center point and restricting or disabling one or more predetermined functionalities of the network device when the network device is within the restricted area. Additionally, an instance of the software application installed on the network device may be capable of monitoring movements of and/or operations conducted by the network device and providing notifications in response to one or more predetermined triggering events.

More particularly, in one embodiment, the CFZ system may include a cloud server configured to execute logic stored thereon to transmit data between one or more of a monitoring network device, a magnetic device including one or more magnets, and a monitored network device. Specifically, the monitored network device may receive user input selecting or providing a list of functionalities of the monitored network device. A software application installed on the monitored network device receives the list of functionalities from the monitoring networking device, e.g., optionally via the cloud server, and disables the list of functionalities when the monitored network device is within a predefined range of the magnetic device.

In one example, the monitoring network device may be a parent's mobile device, the monitored network device may be a child's mobile device and the magnetic device may be located within an automobile, e.g., coupled to the steering column. In such an example, the parent may restrict the use of certain functionalities of the child's mobile device while the child is driving by defining a list of functionalities to be restricted or disabled and establishing a restricted zone around the magnetic device based on a strength of the magnetic field generated by the magnetic device. When a magnetometer of the child's mobile device detects a magnetic field having a strength greater than or equal to a first threshold, a software application installed on the child's mobile device determines the child's mobile device is within the restricted zone (e.g., a magnetic field weakens as it propagates from its source) and restricts or disables the list of functionalities. For example, the list of functionalities to be restricted or disabled may include texting applications, email applications, maps applications, social media applications, etc.

Additionally, a wireless transceiver may be included within the CFZ system to prevent the obfuscation of the magnetic field, e.g., by movement of the magnetic device. The wireless transceiver, located within proximity of the magnetic device, may transmit a wireless signal, such as a beacon signal for example, to be received by the monitored network device. The wireless signal notifies the software application of the monitored network device to search for a magnetic field. When a wireless signal is received and a magnetic field is not detected, the software application determines the magnetic field has been obfuscated. In such a situation, the software application may transmit an alert to the monitoring network device, optionally via the cloud server, notifying the user of the monitoring network device of the potential removal of the magnetic device.

Continuing the example above, the wireless transceiver may be located within the automobile, e.g., integrated behind the center console or as a standalone electronic device. The child's mobile phone may receive a wireless signal from the wireless transceiver and begin searching for a magnetic field. Upon detecting the magnetic field, the software application of the child's mobile device determines whether the strength of the magnetic device is greater than or equal to the first threshold and restricting or disabling the list of functionalities when the strength of the magnetic field is greater than or equal to the first threshold. However, when the wireless signal is received but a magnetic field is not detected (or the strength is below a second threshold), the software application determines the magnetic field has been obfuscated and may transmit an alert, optionally via the cloud server, to the parent's mobile device alerting the parent to the obfuscation. Thus, the child is prevented from tampering with or moving the magnetic device in order to circumvent the disabling or restricting of the list of functionalities. As a result, the child cannot circumvent the disabling or restricting of the list of functionalities when the child is driving, at least not without a parent being notified.

Although the example above discusses the CFZ system as used with an automobile and a parent-child relationship, the disclosure should not be so limited. The CFZ system may be used in any area in which the magnetic device, and optionally the wireless transceiver, are placed. For example, the CFZ system may be used in the home, workplace, office building, coffee shop, restaurant, on public transportation (e.g., a bus, train, airplane, etc.), sporting stadium, etc. Additionally, the CFZ system may be used with any relationship involving a monitoring network device and a monitored network device. For example, the CFZ system may be used with an employer-employee relationship, a parent-parent relationship, a guardian-child relationship, etc. However, for ease and convenience, a parent-child relationship using the CFZ system within an automobile will be discussed herein.

In one embodiment, a parent may access the CFZ system (e.g., via an internet browser or downloading a corresponding software application), creating an account, inviting a child to register and configuring the child's account by selecting certain functionalities the parent wishes to disable or restrict while the child is driving. The child may then download the software application to the child's mobile device. The parent may then configure the software application on the child's mobile device by establishing a restricted area that surrounds the magnetic device installed within an automobile and is defined by the strength of the magnetic field. The restricted area is established by using magnetometers within the child's mobile device to detect the strength of a magnetic field generated by the magnetic device. Subsequently, the software application establishes a virtual restricted zone with the magnetic device at the center and including at least the area surrounding the driver's seat. As a result of the establishment of the restricted area, a child's mobile device will have limited functionality when the mobile device is within reach of the child while the child is driving; thus, decreasing the number of distractions presented to the child while driving. As mentioned above, the parent may configure the software application on the child's mobile device to silence all notifications, prevent texting, emailing, or generally the generation, transmission and/or receipt of messages, prevent the use of social media (e.g., Facebook®, Instagram®, Snapchat®, etc.), etc.

Accordingly, using the CFZ system decreases the distractions presented to a child while the child is driving, or sitting in the driver's seat with the car on, in a manner customizable by a parent, guardian, employer, etc. As a result, the CFZ system may improve the safety of a child's driving. Further, the CFZ system may be applied to any mobile device, such as a parent's mobile device, in order to decrease the distractions presented to any driver of the automobile. Additionally, the software application, e.g., installed on a plurality of mobile devices, may be configured differently according to the desires of a parent, guardian, employer, etc. For example, a parent may configure the software application installed on a first child's mobile device to disable all functionality of the mobile device (e.g., the first child may be just learning to drive) and configure the software application installed on a second child's mobile device to disable a portion of the functionality less than all of the functionality of the mobile device (e.g., the second child has more experience driving).

### I. Terminology

In the following description, certain terminology is used to describe features of the invention. In certain situations, the term “logic” is representative of hardware, firmware, and/or software that is configured to perform one or more functions. As hardware, the logic may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the logic may be software in the form of one or more software modules. The software module(s) may include an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

The term “wireless transceiver” refers to an electronic device configured to transmit and/or receive a wireless signal. The wireless transceiver may transmit data using any wireless technology, examples of which may include, but are not limited or restricted to, Wi-Fi, Bluetooth®, Bluetooth Low Energy, radio waves (e.g., radio-frequency identification), one or more beacons, etc. In one embodiment, a wireless transceiver may refer to a communication interface of the center console of an automobile. In a second embodiment, a wireless transceiver may refer to a standalone electronic device that provides a wireless communication interface.

The term “computerized” generally represents that any corresponding operations are conducted by hardware in combination with software and/or firmware.

The term “network device” may be construed as a physical, electronic device or a virtual electronic device that is based on the execution of one or more software modules. The network device may be communicatively coupled to a public network such as the Internet or a private network such as a wireless data telecommunication network, wide area network, a type of local area network (LAN), or a combination of networks. Examples of the network device may include, but are not limited or restricted to, a physical electronic devices (e.g., a personal computer such as a desktop, laptop, tablet or netbook; a mobile phone; a standalone appliance; a sensor; etc.). A network device may feature a plurality of electronic components, including one or more hardware processors (generally referred to as “processor”), at least one non-transitory storage medium, and an (network and/or I/O) interface. These components may be encased in a housing, which may be made entirely or partially of a rigid material (e.g., hard plastic, metal, glass, composites, or any combination thereof) that protects these components from certain environmental conditions.

The term “message” generally refers to any type of signaling such as wireless signaling including a beacon signal. Alternatively, the message may be information in a prescribed format and transmitted in accordance with a suitable delivery protocol. Hence, each message may be in the form of one or more packets, frames, or any other wireless signaling having the prescribed format.

The term “transmission medium” may be construed as a physical or logical communication path between two or more electronic devices. For instance, as a physical communication path, wired and/or wireless interconnects in the form of electrical wiring, optical fiber, cable, bus trace, or a wireless channel using infrared, radio frequency (RF), may be used.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

Cell Free Zone System

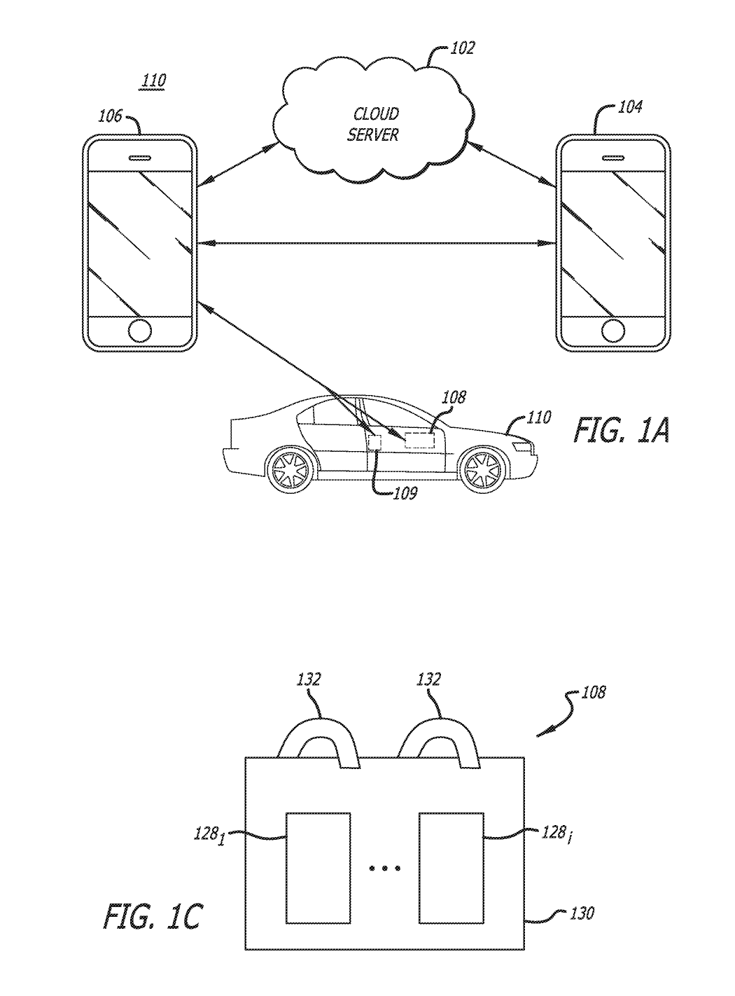

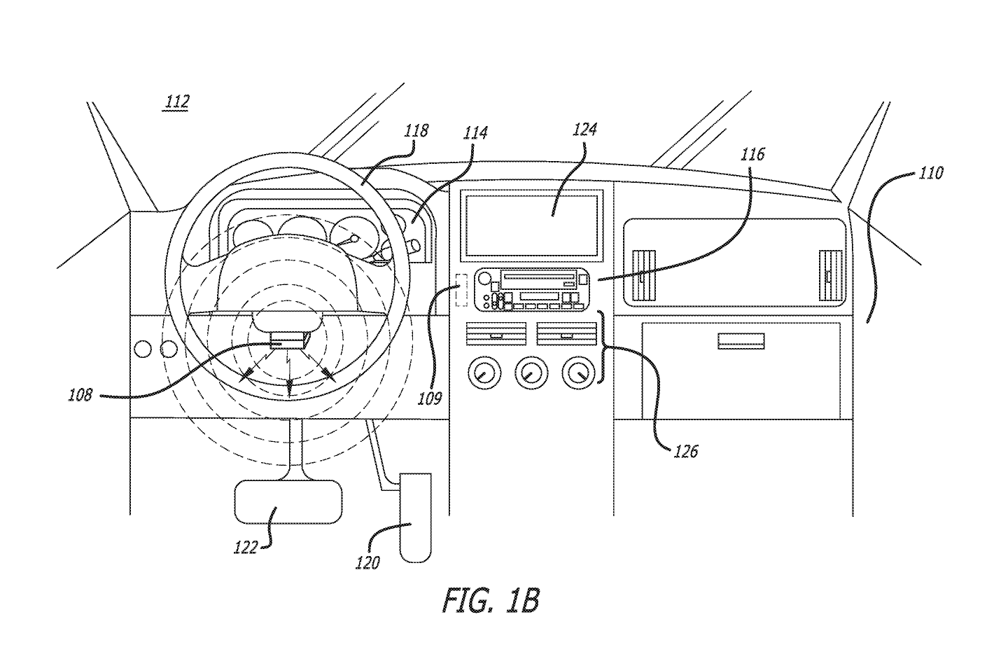

Referring to FIG. 1A, an exemplary illustration of Cell Free Zone (CFZ) system is shown. The CFZ system 100 includes a cloud server 102, a first (monitoring) network device 104 (e.g., a parent or employer's mobile device), a second (monitored) network device 106 (e.g., a child or employee's mobile device) as well as a magnetic device 108 and a wireless transceiver 109 installed in an automobile 110. As shown, the cloud server 102 is communicatively coupled to the first network device 104 and the second network device 106. Additionally, the second network device 106 may be communicatively coupled to the first network device 104 and configured to receive and/or detect signals transmitted by the magnetic device 108 and the wireless transceiver 109. Additionally, the network devices 104-106 each include a processor (e.g., circuitry) that is configured to execute logic stored within a storage medium of each of the network devices 104-106. One example of the processor includes an Intel® (x86) central processing unit (CPU) with an instruction set architecture. Alternatively, each processor may include another type of CPU, a digital signal processor (DSP), an Application Specific Integrated Circuit (ASIC), a field-programmable gate array (FPGA), or any other hardware component with data processing capability.

Referring to FIG. 1B, an exemplary illustration of an interior cabin of an automobile including the magnetic device and the wireless transceiver of FIG. 1A is shown. Herein, the interior cabin 112 of the automobile 110 includes a dashboard 114, a center console 116, a steering wheel 118, a gas pedal 120, a brake pedal 122, the magnetic device 108 and the wireless transceiver 109. In the embodiment illustrated in FIG. 1B, the center console 116 is shown to include a display screen 124 and a plurality of controls 126, e.g., entertainment system controls, cabin climate controls, automobile safety feature controls, etc.

The magnetic device 108 may be permanently affixed or removably coupled to a steering column of the automobile 110; however, any location within the interior cabin of the automobile may be used. The magnetic device 108 may include one or more magnets that emit magnetic signaling to form a magnetic field. Examples of the magnets that may be used include, but are not limited or restricted to, permanent magnets (comprised of materials including, e.g., alnico (Aluminum Nickel Cobalt alloy) and/or ferrites (ceramic-like material comprised of materials including, e.g., iron oxides, nickel, strontium, and/or cobalt) and/or electromagnets (comprised of materials including, e.g., ceramic, alnico, and neodymium). The magnetic field generated by the magnetic device 108 has the purpose of being detected by a magnetometer of the network device 106 when located within the automobile 110. As will be discussed below, the magnetometer of the network device 106 determines the strength of the magnetic field (e.g., determining the distance between the network device 106 and the magnetic device 108). When the strength of the magnetic field is determined to be greater than or equal to a predetermined threshold, a software application installed on the network device is initiated. The software application is configured to disable one or more functionalities of the network device 106 according to predetermined configurations so long as the network device 106 remains within a predefined distance from the magnetic device 108 (i.e., the magnetic field strength remains greater than or equal to the predetermined threshold). Specifically, the purpose of the magnetic device 108 is to enable the software application of the network device 106 to determine whether the network device 106 is within a predefined range of the magnetic device 108 and disable predefined functionalities of the network device 106 in such a situation.

In other embodiments, the magnetic device 108 may be coupled to the steering wheel 118 itself, so long as such a coupling does not impede a driver's ability to safely operate the automobile 110. Further, the magnetic device 108 may be coupled to other portions of the automobile 110, including, for example, the center console 116, the dashboard 114, the driver's seat, etc.

In one embodiment, the wireless transceiver 109 is installed behind a front surface of the center console 116 as part of the entertainment system controls to transmit and receive wireless data. In another embodiment, the wireless transceiver 109 may be a standalone electronic device that is placed within the automobile 110 (e.g., to enable use of the CFZ system with older automobiles that may not have Bluetooth™ connectivity). In yet another embodiment, the wireless transceiver 109 may be located within the magnetic device 108. The wireless transceiver 109 may be configured to facilitate communication between a network device and the center console via, inter alia, Wi-Fi, Bluetooth®, Bluetooth Low Energy, one or more beacons, etc. In particular, the wireless transceiver 109 may prevent or alert a monitoring network device to obfuscation of the magnetic field generated by the magnetic device 108 by transmitting a signal, e.g., a beacon, that is received by the network device 106 and notifies the network device 106 to search for a magnetic field generated by the magnetic device 108. When a beacon is received by the network device 106 and no magnetic field is detected, the software application of the network device 106 determines the magnetic field has been obfuscated (e.g., the magnetic device 108 may have been moved, for example, to the trunk of the automobile). The wireless transceiver 109 has one purpose, inter alia, of preventing modification or movement of the magnetic device 108 that would allow a driver to circumvent the disabling of functionalities of the network device 106. Additionally, the receipt of a beacon from the wireless device 109 by the network device 106 may prompt the network device 106 to launch the software application and begin searching for a magnetic field.

Referring to FIG. 1C, an exemplary block diagram of a magnetic device is shown. The magnetic device 108 is shown to include one or magnets 128₁-128ᵢ (i≥1) at least partially contained within a housing 130. The magnetic device 108 also includes an optional attachment mechanism 132. In one embodiment, the attachment mechanism 132 may be an adhesive applied to a top surface of the housing 130. In another embodiment, the attachment mechanism 132 may be a securing mechanism, such as straps or hooks for example. In a second embodiment, the attachment mechanism 132 may be an extension of the housing 130 and integrally formed therefrom. As discussed, the magnetic device 108 may be removably coupled or permanently affixed to a portion of the automobile 110, e.g., the steering column.

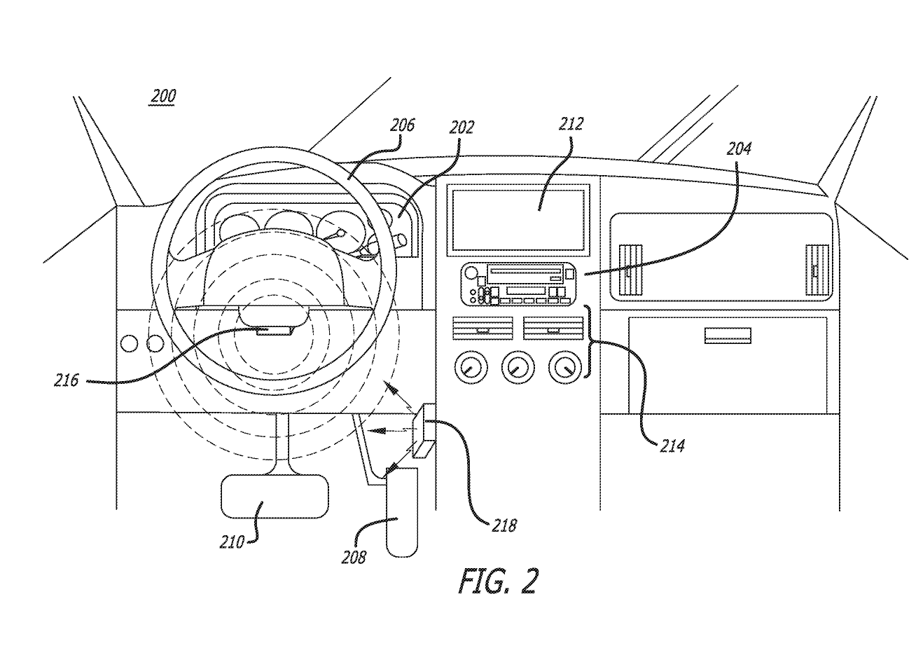

Referring to FIG. 2, an exemplary illustration of an interior cabin of a second automobile including a magnetic device and a wireless transceiver installed therein is shown. Herein, the interior cabin of the second automobile 200 includes a dashboard 202, a center console 204, a steering wheel 206, a gas pedal 208, a brake pedal 210, the magnetic device 108 and the wireless transceiver 218, as shown in FIG. 1B. In the embodiment illustrated in FIG. 2, the center console 204 is shown to include a display screen 212 and a plurality of controls 214, e.g., entertainment system controls, cabin climate controls, automobile safety feature controls, etc. In contrast to FIG. 1B, the standalone wireless transceiver 218 is provided. The wireless transceiver 218 transmits wireless signals, e.g., one or more beacons, that are received by the network device 106. As discussed above with respect to FIGS. 1A-1B, the receipt of beacons from wireless transceiver 218 by the network device 106 may cause the network device 106 to search for a magnetic field and determine a magnetic field generated by the magnetic device 108 has been obfuscated when no magnetic field is detected.

Registration and Configuration Methodology

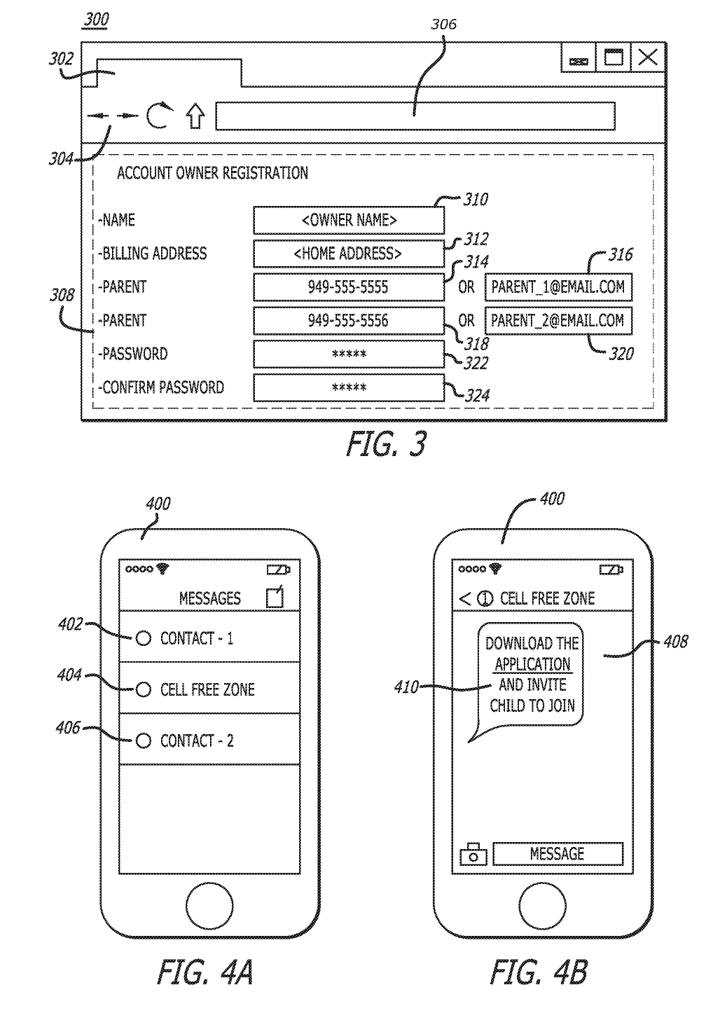

Referring to FIG. 3, an exemplary display screen illustrating an internet browser presenting an account owner registration webpage is shown. The display screen 300 illustrates an internet browser 302 having a navigation toolbar 304, a location bar 306 and a content area 308, which includes an owner name text box 310, an owner billing address text box 312, first parental contact information text boxes 314-316, second parental contact information text boxes 318-320, a password text box 322 and a password confirmation text box 324. The display screen 300 is used by an account owner, e.g., a parent or car owner, to register with the CFZ system. Particularly, the owner name text box 310 may correspond to any parent, guardian, employer, etc. that will have the ability (e.g., permission) to set and/or modify the configuration settings for a user's account (e.g., restrict capabilities of a user's network device) as well as invite others to join (e.g., anyone that may drive an automobile to which a magnetic device is coupled).

The account owner registers by completing text boxes 310-312, at least one of either set of parental contact information text boxes 314-316 or 318-320, and the password and password confirmation text boxes 322-324. It should be noted that the account owner may be a parent corresponding to either set of parental contact information text boxes 314-316 or 318-320. Although in one embodiment, the account owner does not have to be a parent corresponding to either set of parental contact information text boxes 314-316 or 318-320. Additionally, although two sets of parental contact information text boxes are shown, more or fewer sets of parental contact information text boxes may be included. Additionally, an account owner may register a particular magnetic device via a device registration text box, not shown, which may act to attach a particular product warranty to the device, etc.

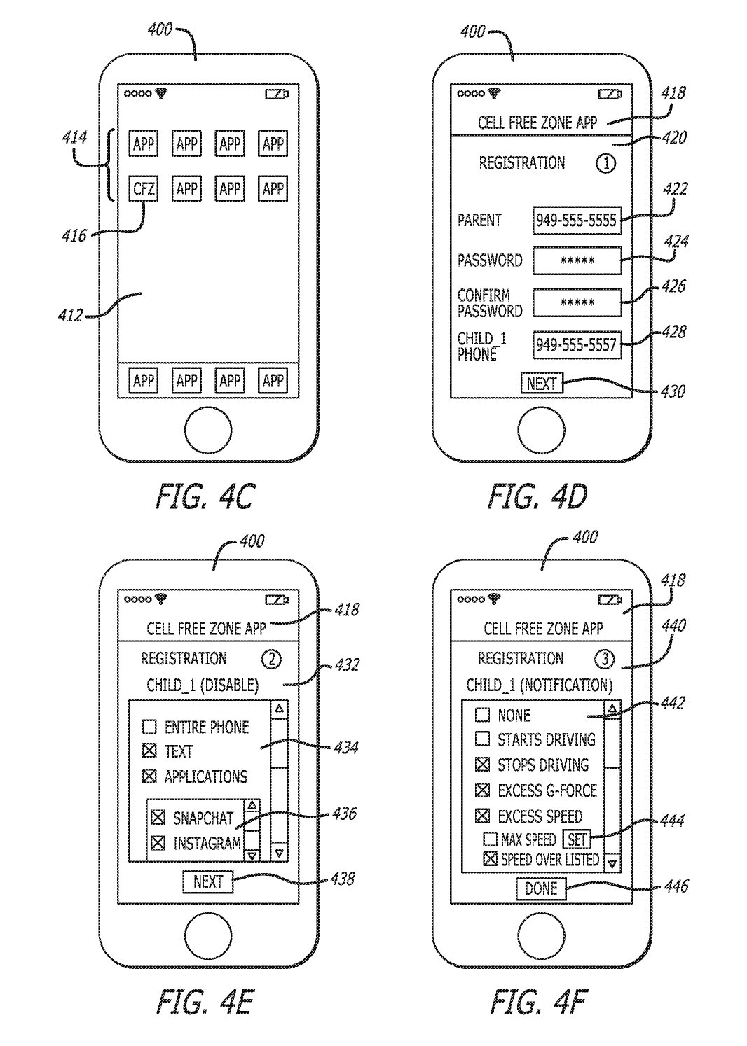

Referring to FIGS. 4A-4F, a plurality of display screens displayed on a network device illustrating a process followed by a parent to register with the CFZ system is shown. Referring to FIG. 4A, a network device 400, e.g., a mobile device, is shown displaying a “Messages” screen presenting the user of the mobile device with a plurality of text message alerts. The text message alerts include a first text message alert 402 from Contact-1, a second text message alert 404 from Cell Free Zone and a third text message alert 406 from Contact-2. Selecting, e.g., via user input, to read the text message pertaining to the second text message alert 404 may result, directly or indirectly, in the display illustrated in FIG. 4B. Although FIGS. 4A-4F illustrate the invention utilizing text messaging as a communication method to communicate with a parent, the invention should not be so limited. Instead, any form of electronic communication may be used such as, for example, email, messaging via social media platforms (e.g., Facebook®, Instagram®, Snapchat®, etc.) and or messaging via any dedicated messaging application for network devices (e.g., WhatsApp®).

Referring to FIG. 4B, the network device 400 of FIG. 4A is shown displaying text messages from Cell Free Zone. A text message screen 408 illustrates a thread of text messages between the Cell Free Zone and the parent operating to the network device 400. The thread includes a message 410 that includes a link to download software application on the network device 400. It is noted that as many applications share content among a plurality of network devices (e.g., network devices configured with a common login, for example within the Apple® ecosystem, or with a single application using a single login across multiple devices); therefore, the message 410 may be used to install the software application on multiple devices. Selecting the link provided in the text message 410 may result, directly or indirectly, in the display of the illustration set forth in FIG. 4C.

Referring to FIG. 4C, an exemplary illustration of a network device displaying a home screen including an icon corresponding to the software application is shown. A home screen 412 is displayed on the network device 400. The home screen 412 is shown to include a plurality of icons 414 representing a plurality of applications that have been installed on the network device 400. In an alternative embodiment, at least a part of one or more of the plurality of applications may reside on cloud storage such that selection of an icon of the plurality of icons 414 results in retrieval of data from cloud storage. The plurality of icons 414 includes an icon 416 corresponding to the software application, which may be downloaded and installed on the network device 400 and/or at least partially stored on cloud storage. Selecting the icon 416 corresponding to the software application may result, directly or indirectly, in the display of the illustration set forth in FIG. 4D.

Referring to FIG. 4D, the network device 400 of FIG. 4A is shown displaying a first display screen of the software application. A content area 420 is displayed and corresponds to a registration screen for a parent. The content area 420 includes a plurality of text boxes for a parent to fill in in order to register with the CFZ system including a parent phone number text box 422, a password text box 424, a password confirmation text box 426, and a child_1 phone number text box 428. The parent's phone number is used in transmission of notifications pertaining to a child's driving, as will be discussed below and a password is established upon completion of the text boxes 424-426. The password will be required when an attempt to sign in to the parent's account is made, e.g., when modifications to the configuration settings of a child's account are desired. The phone number provided in text box 428 corresponds to a first child (or other driver) that will be utilizing the automobile in which a magnetic device is installed. Filling in the text boxes 422-428 and selecting the “Next” icon 430 may result, directly or indirectly, in the display of the illustration set forth in FIG. 4E.

Referring to FIG. 4E, the network device 400 of FIG. 4A is shown displaying a second display screen of the software application. A content area 432 is displayed and corresponds to a second registration screen that is configured for a parent to select one or more functionalities that are to be disabled when the child's mobile device is within a predefined area within an automobile within which a magnetic device is installed. The content area 432 includes a scroll list 434 that lists functionalities of the child's mobile device that may be restricted or disabled. Examples of functionalities that may be restricted or disabled via the software application installed on the child's mobile device include, but are not limited or restricted to, disabling all functionalities (e.g., “entire phone”), disabling texting functionalities, disabling one or more applications, etc. In particular, the content area 432 may include a sub-scroll list 436 that lists individual applications installed on the child's device (or that may be installed on the child's device). In one embodiment, the CFZ system may be configured to receive a notification from the software application installed on the child's device and the notification may include a listing of applications installed on the child's mobile device such that the sub-scroll list 436 may be populated with the applications installed on the child's mobile device. Additionally, the CFZ system may receive notifications periodically, upon request, or upon a triggering event (e.g., a new application was installed) from the software application installed on the child's mobile device alerting the CFZ system of any additional applications that have been installed on the child's mobile device. A parent, e.g., operating the network device 400, may then be alerted to the new applications and decide if the new applications should be disabled when the child's mobile device is within the predefined range of the magnetic device. In a second embodiment, the sub-scroll list 436 may include a list of all possible applications that may be installed on the child's mobile device. In such an embodiment, the software application installed on the child's mobile device will disable any applicable applications selected by the parent according to the second display screen set forth in FIG. 4E. It should be noted that upon completion of the registration process by the parent operating the network device 400, the configuration settings are stored by the CFZ system (e.g., in a remote storage location and/or using cloud storage) and may also be transmitted to the child's mobile device (e.g., the mobile device corresponding to the number provided in the text box 428 of FIG. 4D. In some embodiments, the parent may configure a child's account to communicate with a predetermined magnetic device (e.g., via magnetic device registration as mentioned above). In other embodiments, a child's account may be configured to recognize all magnetic devices. Further, receiving input that selects the “Next” icon 438, may result, directly or indirectly, in the display of the illustration set forth in FIG. 4F.

Referring to FIG. 4F, the network device 400 of FIG. 4A is shown displaying a third display screen of the software application. A content area 440 is displayed and corresponds to a third registration screen that is configured for a parent to select one or more events that trigger the transmission of a notification to the parent (e.g., to the network device 400, to one or more other network devices in addition to the network device 400, etc.). The content area 440 includes a scroll list 442 that lists events that are selectable to act as triggering events. Examples of event that may act as triggering events for the transmission of notifications to the parent include, but are not limited or restricted to, none (e.g., no notifications), start driving, stop driving, excess G-Force, excess speed (e.g., a predefined max speed via icon 444, a speed over the listed speed for that road, etc.), etc. The receipt of user input to the CFZ system causes the CFZ system to establish a set of triggering events, which act as rules that dictate when the software application installed on the child's mobile device is to report data to the CFZ system (e.g., data pertaining to the triggering event), transmit an alert to the parent, and/or provide an alert to the CFZ system to be further transmitted to the parent (e.g., and optionally stored on the CFZ system). Receiving input corresponding to a selection of the “Done” icon 446, may result, directly or indirectly, in the completion of the registration process set forth in FIGS. 4A-4F.

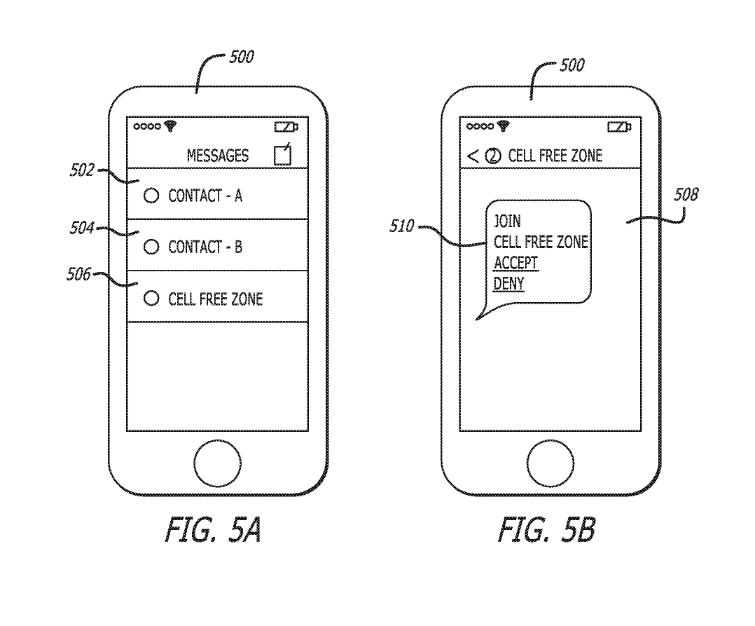

Referring to FIGS. 5A-5B, a plurality of display screens displayed on a network device illustrating a process followed by a child to download the software application is shown. Referring to FIG. 5A, a network device 500, e.g., a mobile device of a child, is shown displaying a “Messages” screen presenting the user of the mobile device with a plurality of text message alerts. The text message alerts include a first text message alert 502 from Contact-A, a second text message alert 504 from Contact-B and a third text message alert 506 from Cell Free Zone. Selecting, e.g., via user input, to read the text message pertaining to the third text message alert 504 may result, directly or indirectly, in the display illustrated in FIG. 5B. Although FIGS. 5A-5B illustrate the invention utilizing text messaging as a communication method to communicate with a child's network device, the invention should not be so limited. Instead, any form of electronic communication may be used as discussed above with respect to FIGS. 4A-4F.

Referring to FIG. 5B, the network device 500 of FIG. 5A is shown displaying a text message from Cell Free Zone. A text message screen 508 illustrates a thread of text messages between the Cell Free Zone and the child operating to the network device 500. The thread includes a message 510 that includes a link to download software application on the network device 500. For example, by receiving user input selecting the “Accept” link, the CFZ system may transmit a notification to the parent that invited the child (e.g., refer to FIGS. 4A-4F) and present the child with an icon configured to initiate the download of the software application on the network device 500 (e.g., via an application “store”). In one embodiment, receiving user input selecting the “Accept” link may cause the network device 500 to automatically begin a download of the software application. In one embodiment, receiving user input selecting the “Deny” link may cause the CFZ system to transmit a notification to the parent that invited the child operating the network device 500 that the invitation to join the CFZ system and download the software application was declined. As discussed above with respect to FIGS. 4A-4F, as many applications share content among a plurality of network devices, the message 510 may be used to install the software application on multiple devices.

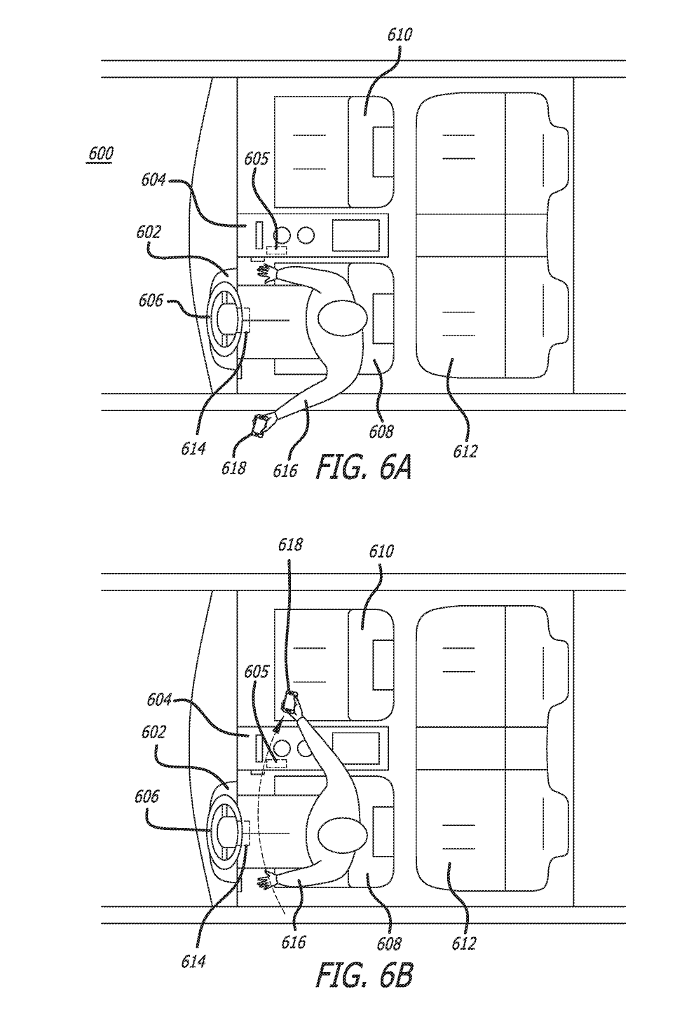

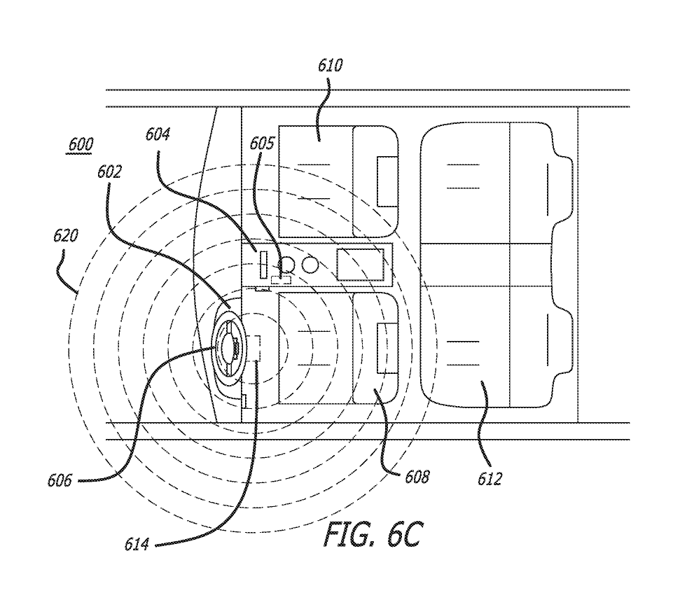

Referring to FIGS. 6A-6B, a plurality of illustrations provide a visual demonstration of the process for configuring a network device, and the software application installed thereon, for use with a magnetic device and a wireless transceiver installed within an automobile is shown. Referring to FIG. 6A, a first exemplary illustration of an interior cabin of an automobile including a magnetic device and a wireless transceiver installed therein is shown. Herein, the interior cabin of the automobile 600 includes a dashboard 602, a center console 604, a wireless transceiver 605, a steering wheel 606, a driver's seat 608, a front passenger's seat 610, a backseat 612 and a magnetic device 614 (previously identified as magnetic device 308). Additionally, a person 616 is shown sitting in the driver's seat 608 holding a network device 618. As discussed above, following download and installation of the software application on the network device 618, a configuration process is undertaken that configures the software application for use with the magnetic device 614.

The process of configuring the software application installed on the network device 618 has the purpose of establishing an area, e.g., a “restricted area,” at least partially covering the driver's seat 608 in which the software application will disable the functionalities predefined by a parent, guardian, employer, etc., as discussed above. In particular, the restricted area forms a virtual region having the magnetic device 614 as a center point. In one embodiment, the region may take the shape of a circle; however, other shapes have been contemplated. The restricted area is a zone in which a parent, guardian, employer, etc., has restricted the use of one or more predefined functionalities of the network device 618 by use of the software application installed thereon. Once the software application has been configured and the restricted area established, the functionalities predefined by a parent, guardian, employer, etc., will be disabled when the automobile is in use and the network device 618 is within the restricted area. Thus, the CFZ system, including the magnetic device 614 and the software application installed on the network device 618, restrict the use of the network device 618 from being used within a predefined range of the magnetic device 614. The CFZ system, as discussed above, limits the distractions to the driver that are provided by the network device 618, e.g., texting, emailing, browsing social media, changing music, etc.

Still referring to FIG. 6A, the configuration of the software application installed on the network device 618 is a multi-step process that includes, inter alia, steps of (i) initiating a measuring phase, which causes the magnetometer of the network device 618 to measure the strength of a magnetic field generated by the magnetic device 614, (ii) continuing to measure the strength of the magnetic field as the network device 618 is moved from a first position to a second position (additional positions are also possible), (iii) determining a value indicating the weakest strength of the magnetic field that was measured during the measuring phase, and (iv) storing the value indicating the weakest strength of the magnetic field for use in creating the restricted area. As an optional initial step, the network device 618 may receive a beacon from the wireless transceiver 605, which may cause the network device 618 to launch the software application and/or identify the presence of the CFZ system.

When the configuration process is initiated, the software application may, either automatically or in response to user input, begin to determine the strength of a magnetic field detected by the magnetometer of the network device 618. In one embodiment, the network device 618 may display a configuration screen, not shown, that receives user input to begin and end the measuring phase. Such an embodiment enables the person 616 configuring the software application installed on the network device 618 to set a beginning time and end time for the measuring phase. As shown in FIG. 6A, the network device 618 is held in a first position with respect to the magnetic device 614.

Referring now to FIG. 6B, a second exemplary illustration of the interior cabin of the automobile of FIG. 6A including the magnetic device and the wireless transceiver installed therein is shown. As illustrated, the person 616 is shown to have moved the network device 618 from a first position (e.g., FIG. 6A) to a second position during the configuration process. During the movement of the network device 618 from the first position to the second position, the magnetometer of the network device 618 measures the strength of the magnetic field generated by the magnetic device 614 while in the measuring phase. The configuration of the software application continues upon the completion of the measuring phase by determining, by the software application, the weakest measured strength of the magnetic field during the measuring phase. The value indicating the weakest measured strength of the magnetic field is stored by the software application and is used by the software application as the threshold indicating when the software application is to disable predefined functionalities of the network device 618. Specifically, the location of the weakest measured strength of the magnetic field indicates the position of the network device 618 when the network device 618 is the farthest from the magnetic device 614 during the measuring phase; therefore, establishing an outer limit for the range within which the software application disables one or more functionalities of the network device 618 (e.g., a perimeter). As a result, the restricted area is established and defined by the value indicating the weakest measured strength of the magnetic field during the measuring phase.

In one example, a parent may establish a restricted area in an automobile for a child's mobile device by sitting in the driver's seat with the mobile device, and turning the automobile on. Upon receiving input by the parent to initiate the configuration process and additionally to begin the measuring phase, the software application obtains readings from the mobile device's magnetometer. As the parent moves the mobile device across multiple positions (e.g., spanning the area reachable by a child sitting in the driver's seat), the software application continues to obtain readings from the magnetometer. The measuring phase is complete when the network device 618 receives user input corresponding to ending the measuring phase. Alternatively, the measuring phase may end upon expiration of a timer. As discussed above, the software application of the network device 618 then determines and stores a value indicating the weakest measured strength of the magnetic field, which is used to establish a perimeter of the restricted zone.

Referring now to FIG. 6C, a third exemplary illustration of the interior cabin of the automobile of FIG. 6A including the magnetic device and the wireless transceiver installed therein is shown. FIG. 6C also illustrates an exemplary restricted area 620. As shown, the restricted area 620 is a circular area having the magnetic device 614 as the center point of the circle and the outer most dotted circular ring representing the perimeter of the restricted area 620. When the network device 618, not shown in FIG. 6C, is located within the restricted area 620 and the automobile 600 is turned on, the network device 618 will receive a wireless signal (e.g., beacon) from the wireless transceiver 605 and detect a strength of a magnetic field that is above a first threshold. As stated above, detection of the strength of the magnetic field above a first threshold indicates to the software application that the network device 618 is within the restricted area. Subsequently, the software application installed on the network device 618 will disable the functionalities predefined by a parent, guardian, employer, etc.

In the embodiment shown, the restricted area 620 is shown to cover the driver's seat 608, a portion of the center console 604, and a portion of the front passenger's seat 610. As a result, a driver is unable to use certain functionalities of the network device 618 and is thus less distracted than if the driver had access to all of the functionalities of the network device 618. It is noted that a passenger, e.g., sitting in either the front passenger's seat 610 or in the backseat 612, may utilize any and all functionalities of the network device 618 when the network device 618 is not within the restricted area 620. The restricted area 620 is illustrated as having a first size (e.g., a first radius); however, the disclosure should not be so limited as the size of the restricted area is configurable as discussed above. Specifically, a restricted area may be configured with a smaller or larger radius than shown in FIG. 6C. Additionally, a restricted area may be specific to each network device. For example, in one embodiment, a first network device may be configured with a first restricted area having a first size while a second network device may be configured with a second restricted area having a second size, the first size being different than the second size.

General Use Case

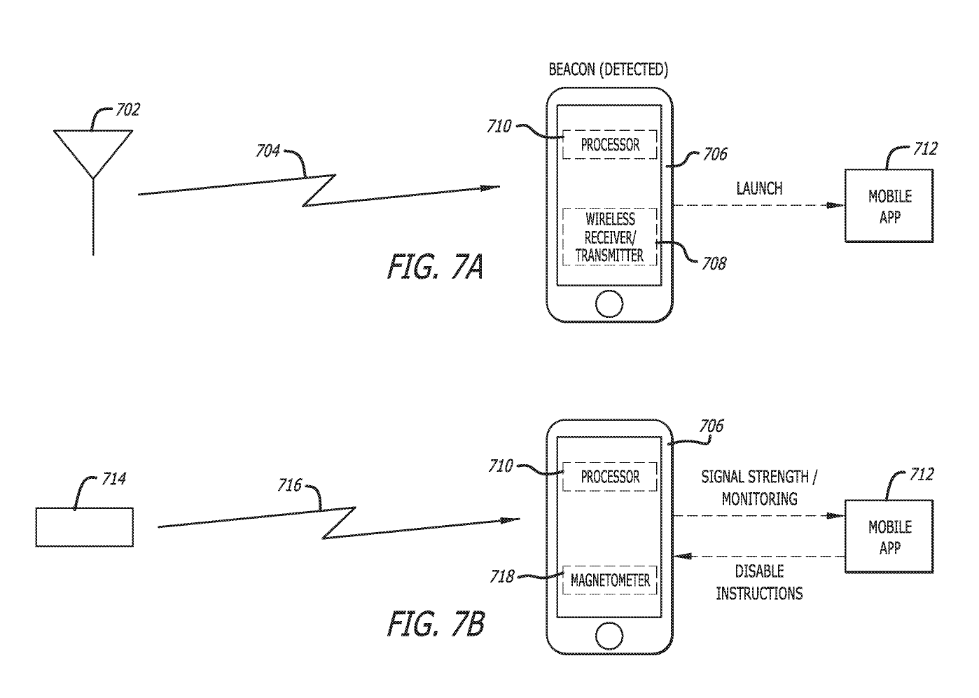

FIGS. 7A-7B provide illustrations of communication pathways between the CFZ system and a network device. Referring to FIG. 7A, an illustration of a wireless signal being transmitted to a network device is shown. The wireless transceiver 702 may be an electronic device configured to transmit and/or receive wireless signals, e.g., beacons, 704. As illustrated in FIG. 7A, the wireless transceiver 702 transmits signals 704 and a wireless receiver/transmitter 708 of the network device 706 is configured to detect the beacon 704. Responsive to detecting the beacon 704, the processor 710 of the network device 706 may launch the mobile application 712, which may be stored on the network device 708 in a storage medium located therein.

Referring to FIG. 7B, an illustration of a magnetic field generated by a magnetic device and detected by the network device of FIG. 7A is shown. The magnetic device 714 may include one or more magnets that generate a magnetic field. As illustrated in FIG. 7B, the magnetic device 714 generates a magnetic field 716 and a magnetometer 718 of the network device 706 is configured to detect the magnetic field 716 as well as the strength thereof. Responsive to detecting the strength of the magnetic field 716 being greater than or equal to a first threshold (e.g., a value indicating a weakest strength detected during a measuring phase as discussed above), the mobile application 712 provides instructions to one or more applications to close, hide notifications and/or restrict or disable functionality. Additionally, the mobile application 712 may itself cause the disabling of predefined functionalities of the network device 706. Upon detection of a strength of the magnetic field that is less than the first threshold, the mobile application 712 permits full functionality of the network device 706 (e.g., provides enabling instructions to one or more applications, revokes the disabling instructions, etc.).

Software Application Monitoring Methodology

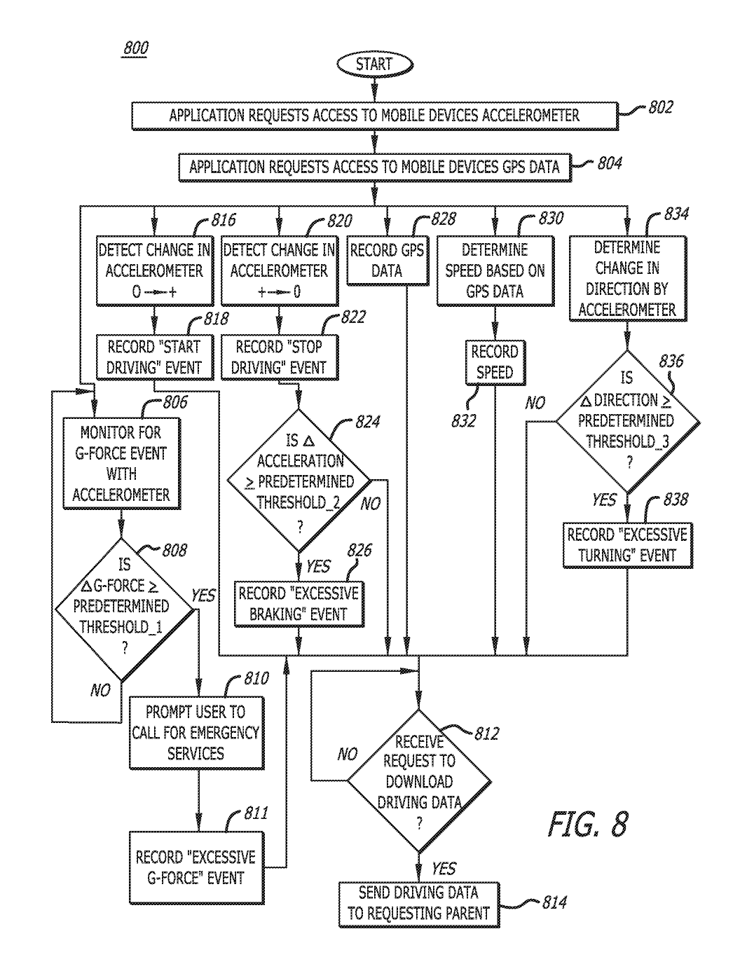

Referring to FIG. 8, a flowchart illustrating an exemplary process for monitoring driving data and providing notifications corresponding thereto is shown. Each block illustrated in FIG. 8 represents an operation performed in the method 800 of monitoring driving data and providing notifications corresponding thereto by a CFZ system. The method 800 is undertaken following a determination by a software application of a network device that the network device is within a restricted area, as discussed above. The process starts and at block 802, the software application installed on the network device, e.g., a mobile device, requests to access the accelerometer of the mobile device. As discussed with respect to the method 800, the mobile device is located within an automobile having a magnetic device installed therein and receives one or more beacons from a wireless transceiver, as discussed above. At block 804, the software application requests access to GPS data of the mobile device. Following the receipt of access to the accelerometer and the GPS data, a plurality of operations may occur concurrently (at least partially overlapping in time). As illustrated in FIG. 8, two or more of blocks 806, 812, 816, 828, 830 and 834 may occur concurrently.

At block 806, the software application monitors for a G-force event with the accelerometer. As used herein, the term “G-force event” may refer to a change in the velocity greater than or equal to a predetermined threshold within a predetermined time period. In one embodiment, a G-force event may correspond to the occurrence of an accident (e.g., a sudden stop wherein the change in velocity is greater than a predetermined threshold).

At block 808, the software application determines whether a change in the G-force is greater than or equal to a predetermined threshold_1. When the change in the G-force is not greater than or equal to the predetermined threshold_1, e.g., no G-force event (no at block 808), the method 800 returns to monitoring for a G-force event. When the change in the G-force is greater than or equal to the predetermined threshold_1, e.g., a G-force event (yes at block 808), the network device may display a pop-up asking if a call to emergency services needs to be made (e.g., an accident occurred) (block 810). Subsequently, or concurrently, to the display of the pop-up, the software application records the occurrence of an excessive G-force event (block 811). At block 812, the software application and/or logic of the cloud server determines whether a request to download driving data has been received (block 812). When no request has been received (no at block 812), the software application continues to monitor for receipt of a request for driving data. When a request has been received (yes at block 812), the software application transmits the driving data to the cloud server and/or directly to the parent device requesting the driving data (block 814).

At block 816, the software application detects a change in the accelerometer (from a zero (0) value to a positive measurement) representing a “start driving” event. At block 818, the software application records a start driving event along with applicable metadata (e.g., time, date, GPS location, etc.). The process 800 may then proceed to block 812 and determine whether a request for driving data was received, although such an operation may occur concurrently with blocks 816 and 818.

At block 820, the software application detects a change in the accelerometer (from a positive measurement to a zero (0) value) representing a “stop driving” event. At block 822, the software application records a stop driving event along with applicable metadata (e.g., time, date, GPS location, etc.). The software application then determines whether the change in acceleration is greater than or equal to a predetermined threshold _2 (block 824). When the change in acceleration is greater than or equal to a predetermined threshold _2 (yes at block 824), the software application records an “excessive braking” event (block 826). It should be noted that two or more events may correspond to the same portion of driving data. For example, a sudden stop may result in the recordation of a G-force event and a stop driving event. The process 800 may then proceed to block 812 and determine whether a request for driving data was received, although such an operation may occur concurrently with blocks 820, 822, 824 and 826.

At block 828, the software application records the GPS data (e.g., time, date, speed, etc.). The process 800 may then proceed to block 812 and determine whether a request for driving data was received, although such an operation may occur concurrently with block 828. At block 830, the software application determines a speed of the automobile based on the GPS data. At block 832, the software application records the automobile speed along with applicable metadata (e.g., time, date, GPS location, etc.). The process 800 may then proceed to block 812 and determine whether a request for driving data was received, although such an operation may occur concurrently with blocks 830 and 832.

At block 834, the software application determines a change in a direction of the automobile has occurred based on a change of measurements by the accelerometer. At block 836, the software application determines whether the change in direction is greater than or equal to a predetermined threshold _3 (block 836). When the change in direction is greater than or equal to a predetermined threshold _3 (yes at block 836), the software application records an “excessive turning” event (block 838). The process 800 may then proceed to block 812 and determine whether a request for driving data was received, although such an operation may occur concurrently with blocks 834, 836 and 838.

Provision of Notifications Methodology

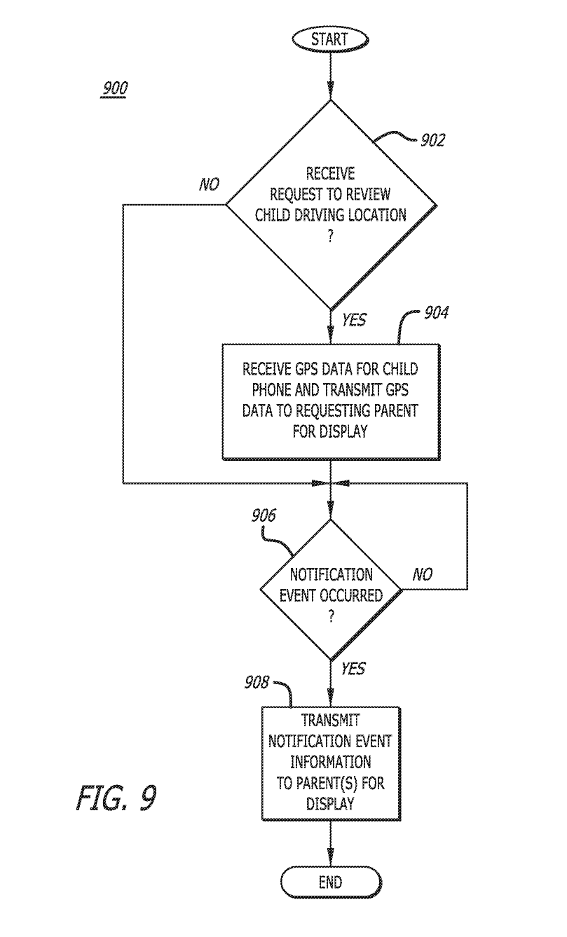

Referring now to FIG. 9, a flowchart illustrating an exemplary process for providing notifications corresponding to a child's driving is shown. Each block illustrated in FIG. 9 represents an operation performed in the method 900 of providing notifications corresponding to a child's driving by a CFZ system. Herein, the process starts and at block 902 the CFZ system determines whether a request to review a child's driving location has been received. When a request to review a child's driving location has been received (yes at block 902), the CFZ system requests and receive GPS data from the child's and transmits the child's GPS data to network device of the requesting parent for display (block 904). When a request to review a child's driving location has not been received (no at block 902), the method 900 proceeds to block 906.

At block 906, the CFZ system determines if one or more notification events have occurred. In one embodiment, a notification event may be a triggering event that has been predefined for a particular child by a parent. As discussed above with respect to FIGS. 4A-4F, a parent, guardian, employer, etc., may select one or more events, the occurrence of which result in the generation of a notification to the parent, guardian, employer, etc. Examples of events that may be notification events include, but are not limited or restricted to, a start driving event, a stop driving event, an excessive G-force event, an excess speed event, a max speed event, a speed over listed speed event, a start driving outside of a predefined time range event, etc.

When one or more notification events have not occurred (no at block 906), the process 900 continues to monitor for the occurrence of a notification event. When one or more notification events have occurred (yes at block 906), the CFZ system transmits notification event information to the parent that configured the child's account settings and/or one or more other parents, guardians, employers, etc. (block 908).

In additional embodiments, data may be collected by a software application installed on a monitored network device when the monitored network device is within a restricted area and store the collected data. Subsequently, the stored data may be transmitted periodically, aperiodically or in response to certain triggering events to the cloud server, a monitoring network device and/or other entity (e.g., a federal or state governmental agency such as a Department of Motor Vehicles (DMV) or an insurance company). In one embodiment, the collected data may be provided to the cloud server, a monitoring network device and/or other entity in the form of daily, weekly, monthly, etc. reports detailing the collected data. For example, a monitoring network device (e.g., a parent's mobile device) may receive weekly reports detailing the driving data of a child based on the data collected by the monitored network device (e.g., the child's mobile device) while the child's mobile device is in the restricted area of an automobile. In a second example, a monitoring device may be an insurance company and the monitored device may be a driver's mobile device. In such an example, the insurance company may receive weekly, monthly, yearly, etc. reports detailing the data collected by the driver's mobile device with in a restricted area. The insurance company may utilize the report to determine insurance premiums. In yet another example, a monitoring device may be an employer's network device and a monitored device may be an employee's mobile device. In such an example, the employer may receive daily, weekly, monthly, etc. reports detailing the data collected by the employee's mobile device while in a restricted area of a company-issued automobile. In an example in which the DMV receives a driver's collected data, the DMV may automate renewal of a license, revocation of a license and/or require the driver to take a driving course or driving exam based on the collected data. Furthermore, the generation of alerts, as discussed above, may also apply to any possible relationship (e.g., parent-child, employer-employee, entity-driver, etc.)

Although the disclosure focuses on the embodiment in which the CFZ system is implemented using an automobile, the disclosure should not be so limited. Instead, the CFZ system may be utilized in any space, for example, an area within an office building, an area within a library, on public transportation systems (e.g., train, taxi or plane), an area in a home, an area in an elementary school, high school, university, etc., or the like.

In the foregoing description, the invention is described with reference to specific exemplary embodiments thereof. However, it will be evident that various modifications and changes may be made thereto without departing from the broader spirit and scope of the invention as set forth in the appended claims.

1. A system for restricting use of a first network device, the system comprising:
one or more magnets to generate a magnetic field;
a wireless transceiver to communicatively couple with the first network device; and
a software application configured to be installed on the first network device,
wherein (i) the wireless transceiver is configured to transmit a message to the first network device to instruct the software application to obtain a first value indicating a strength of the magnetic field, (ii) responsive to the first value indicating the strength of the magnetic field is greater than or equal to a first threshold, the software application is configured to restrict a predefined list of one or more functionalities of the first network device, and (iii) responsive to the first network device being unable to detect the magnetic field, determining that the one or more magnets have been obfuscated and transmitting an alert, by the software application, indicating that the one or more magnets have been obfuscated.

2. The system of claim 1, wherein the one or more magnets are included in a housing that is configured to be coupled to a steering column of an automobile.

3. The system of claim 1, wherein the wireless transceiver is integrated into an automobile.

4. The system of claim 1, wherein the first network device is a mobile phone.

5. The system of claim 1, wherein the software application obtains the strength of the magnetic field from a magnetometer of the network device.

6. The system of claim 1, further comprising:
a cloud server communicatively coupled to the software application.

7. The system of claim 6, wherein the one or more functionalities are provided to the software application via the cloud server as a result of user input received by a second network device, wherein the second network device transmits data based on the user input to the cloud server.

8. The system of claim 1, wherein an area is defined by the strength of the magnetic field, and the strength of the magnetic field at a perimeter of the area is equal to the first threshold.

9. (canceled)

10. A method comprising:
receiving, by a cloud server, a predefined list of one or more functionalities, the predefined list generated via user input;
communicatively coupling, by a wireless transceiver, with a first network device;
transmitting, by the wireless transceiver, a first message to the first network device, the first message configured to prompt a software application installed on the first network device to detect a first value indicating a strength of a detected magnetic field, wherein the magnetic field is generated by one or more magnets;
responsive to the first value indicating the strength of the detected magnetic field is greater than or equal to a first threshold, restricting, by the software application, the predefined list of one or more functionalities of the first network device; and
responsive to the first network device being unable to detect the magnetic field, determining that the one or more magnets have been obfuscated and transmitting an alert, by the software application, indicating that the one or more magnets have been obfuscated.

11. The method of claim 10, wherein the software application obtains the first value indicating the strength of the detected magnetic field via a magnetometer of the first network device.

12. The method of claim 11, further comprising:
periodically obtaining, by the software application, additional values indicating current strength of the detected magnetic field from the magnetometer.

13. The method of claim 12, further comprising:
responsive to obtaining a second value indicating the current strength of the magnetic field that is less than the first threshold, enabling the predefined list of one or more functionalities of the first network device.

14. The method of claim 10, further comprising:
recording, by the software application, data from the first network device when the strength of the detected magnetic field is greater than or equal to a first threshold, wherein the data includes at least one of acceleration data or global positioning system (GPS) data.

15. The method of claim 14, wherein the acceleration data includes at least one of: (i) a start event corresponding to a first acceleration of the network device from a stationary position, (ii) a stop event corresponding to a first deceleration of the network device resulting in the network device being stationary, (iii) an excessive turning event corresponding to a change in a direction of movement of the first network device, wherein the change in the direction is greater than a predetermined turning threshold, or (iv) an excessive G-force event corresponding to a change in a G-force of the first network device, wherein the change in the G-force is greater than a predetermined G-force threshold.

16. The method of claim 14, further comprising:
transmitting, by the software application, a notification to the cloud server providing information to the data recorded from the first network device.

17. (canceled)

18. The system of claim 1, wherein obtaining of the first value and the second value is performed while the first network device is within an interior cabin of an automobile.

19. The method of claim 10, wherein detection of the first value and the second value is performed while the first network device is within an interior cabin of an automobile.

20. The system of claim 1, wherein (iv) responsive to the software application obtaining a second value indicating the strength of the detected magnetic field is less than the first threshold, the software application is configured to enable the predefined list of one or more functionalities of the first network device.

21. The system of claim 1, wherein the one or more magnets having been obfuscated indicates that the one or magnets have been moved from a predetermined location.

22. The method of claim 10, wherein the one or more magnets having been obfuscated indicates that the one or magnets have been moved from a predetermined location.
